(19) United States
(12) Patent Application Publication
(10) Pub. No.: US 2026/0273537 A1
(43) Pub. Date: Sep. 17, 2026

(54) TRAY FOR HOLDING PIPETTE TIPS AND COMBINATION OF A TRAY AND AT LEAST ONE PIPETTE TIP

(71) Applicant: Ritter GmbH, Schwabmuenchen (DE)

(72) Inventors: Christian BAUCH, Obermeitingen (DE); Markus FENDT, Markt Wald (DE); Gürhan BELEN, Olching (DE); Sebastian KERTZSCHER, Graben (DE); Frank FINIS, Augsburg (DE)

(21) Appl. No.: 19/560,795

(22) Filed: Mar. 9, 2026

(30) Foreign Application Priority Data
Mar. 17, 2025 (DE) 10 2025 110 261.9

(51) Int. Cl. B01L 9/00

(52) U.S. Cl. CPC B01L 9/543

(57) ABSTRACT

A tray has a holding area with openings that are adapted to the shape of the pipette tips to be inserted in order to hold them in a specific position. The (cylindrical) openings may, for example, be bounded by sleeves. Internal projections, e.g. webs, extend perpendicularly from a lower end of the sleeves and project substantially in the direction of the central axis of an inserted pipette tip. The inner projections rest against the outer wall of the pipette tip and fix it in a predetermined position.

### TECHNICAL FIELD

This application relates to a tray for holding pipette tips comprising at least one placement or holding area, a plurality of holding spaces for inserting one pipette tip each, and a combination of such a tray and at least one pipette tip.

### PRIOR ART

Manual and automatic pipetting devices or pipetting machines for handling pipette tips are used in a variety of analytical applications in which liquids are handled, for example transported, picked up or dispensed, for example in laboratories. Disposable pipette tips are used in these devices or machines. Disposable pipette tips are usually conical in shape from top to bottom and may have specially shaped sections for gripping and sealing the pipette tips against a coupling device of the device or machine that engages with the interior of the pipette tip. Pipetting devices or automated pipetting machines usually grip the top of the pipette tip. In many applications, the coupling device is inserted into the upper interior volume of the pipette tip. Pipettes or automated pipetting devices exert negative pressure to draw liquids into the pipette tip and generate positive pressure to dispense liquids.

Pipette tips are usually made from moldable plastic, such as polypropylene, e.g., polypropylene homopolymer (PP-H), polyethylene, or similar, using an injection molding process, as plastics offer a good combination of properties such as chemical resistance, low surface adsorption, transparency (if required), and cost-efficient production. Pipette tips are also manufactured in various sizes in order to enable accurate and reproducible handling of liquids in a wide volume range (nanoliters to milliliters).

In many cases, pipette tips are used in large quantities for the automated processing of a large number of samples and for adding various reagents to samples.

However, there are special applications in which pipette tips made of materials such as ceramic or metal are used, for example, in cases of high chemical requirements, necessary corrosion resistance or temperature resistance, etc. In addition, ceramic pipette tips with smaller dimensions, in particular smaller outlet openings, may be manufactured. However, ceramic or metal pipette tips are much more complex in terms of manufacturing and material use.

In order to enable easy handling of large quantities, pipette tips are often supplied in a pipette tip tray with openings on the top in which the pipette tips are arranged and held in an array. The tray may in turn be arranged or mounted on a carrier. The tray and the carrier form a pipette tip holder, which may be equipped with a lid that covers the pipette tips.

Incidentally, pipette tip holders are designed in such a way that a large number of samples may be analyzed in parallel in analytical laboratories, with each holder being used for specific process steps.

However, the use of plastic pipette tips may prove problematic if the pipette tips become electrostatically charged during handling. Static charging of the pipette tips and other components of the holder may cause the tips to repel each other, which may result in the tips being aligned differently than intended in the tray. As a result, interaction with pipetting devices or automated pipetting systems may be adversely affected, leading to inaccurate handling and thus to erroneous analyses. Electrostatic charge may be transferred in an undesirable manner to a user of a pipetting device. In addition, highly sensitive measuring instruments may be impaired by static charge.

### OBJECT OF THE INVENTION

Based on this, it is an object of the present invention to provide a tray or a holder for pipette tips that allows pipette tips to be securely and accurately positioned and aligned.

### SUMMARY OF THE INVENTION

This object is attained by a tray for holding pipette tips according to claim 1 and a combination of such a tray with at least one pipette tip according to claim 12. Features of the dependent claims relate to preferred embodiments of the invention.

The claims relate to a tray. However, within the scope of the invention, the term “tray” may be understood to include holding devices which are combinations of a tray with other components, as described above, e.g. with a carrier on which the tray is arranged or mounted. The tray and the carrier may be designed as two-piece or one-piece units. The carrier may be designed in the form of a frame or in the form of a housing. Both variants are summarized under the term ‘holding device’. The holding devices may, under certain circumstances, be equipped with a lid that covers the pipette tips.

A tray (or holding device) according to the invention for holding pipette tips comprises at least one placement or holding area, a plurality of receptacles extending through the placement or holding area for inserting one pipette tip each, wherein at least one of the receptacles is adapted to a pipette tip to be inserted in such a way that the pipette tip is locked against horizontal translations (x-y) at a first height and a second height, wherein the first height is spaced from the first height by a distance (t, t2).

In particular, at least one of the receptacles has a first constriction arranged at the first height and a second constriction arranged at the second height.

A tray (or holding device) according to the invention for holding pipette tips comprises at least one placement or holding area, a plurality of receptacles extending through the placement or holding area for inserting one pipette tip each, wherein at least one of the receptacles has a first constriction arranged at the first height and a second constriction arranged at the second height.

The diameter of the first constriction is preferably greater than the diameter of the second constriction. In some embodiments, the diameters of the first constriction and the diameter of the second constriction may be the same.

In the context of the invention, a ‘constriction’ is understood to be a section of the receptacles which provides restriction or limitation of the horizontal mobility of the inserted pipette tip. The constriction may be a limitation having a small axial extension, or a limitation that forms part of a (e.g. cylindrical or conical) surface having a larger axial extension. The constriction may be limited by a frame extending continuously around the circumference of the constriction or by discrete points defining a circumference. The continuous or point-defined circumference is described below as the ‘edge’ of the constriction. There are at least two or more axially offset constrictions per receptacle.

The first constriction may have a first edge that delimits a first opening, and the second constriction may have a second edge that delimits a second opening, wherein one or more of the receptacles are at least partially delimited by wall areas, each of which has a proximal end of the wall area that adjoins the respective first edge, and a distal end of the wall area that adjoins the respective second edge, wherein a pipette tip extends through at least the first constriction and the second constriction when inserted. The first constriction is arranged between an upper opening of a receptacle and a lower end of the receptacle, and the second constriction is arranged below the first constriction between the first constriction and the lower end of the receptacle.

The edges may, but do not have to, completely enclose the openings; instead, they may be formed in sections around the respective opening. The edges of the constrictions may, but do not have to, completely enclose the constrictions; instead, they may be formed in sections around the respective opening or constriction. The diameters mentioned are not to be understood in a purely geometric sense, meaning that the opening or narrowing must be round. Rather, the opening or constriction may be defined by at least two sections or end points through which a (virtual) circle with a diameter within the meaning of the invention passes. In particular, the opening or constriction may be defined by at least two or three sections or end points through which a circle within the meaning of the invention passes or which define a circle with a diameter within the meaning of the invention. The at least two or three sections may form at least two or three contact points or surfaces, or they may form at least two or three horizontal abutment points or surfaces.

Two points already significantly restrict the horizontal mobility of the pipette tip, while three or more points completely restrict or block the horizontal mobility of the pipette tip.

The pipette tips are held precisely in one of the first constrictions and in the corresponding second constriction. Since the outer diameter of pipette tips usually tapers from the proximal end to the distal end, the first constrictions are larger than the corresponding second constrictions. The edges of the first constrictions may form a support for a support step formed in the proximal area (at the proximal upper edge or below, but above the distal end) of the pipette tips, while the second constrictions usually form a boundary for a wall area of the inserted pipette tip that is located between the proximal end of the pipette tip and the distal end of the pipette tip, i.e. closer to the distal end than the support step. However, in another embodiment, a support step of the pipette tip may be designed in such a way that, when the pipette tip is inserted in the receptacle, the support step rests on the edge of the second constriction of one of the receptacles.

The advantages of the design according to the invention lie in improved centering of the pipette tip, as it is locked against tilting. The reduced diameter of the second opening improves the positioning of the tip. This ensures better pick-up by a robot. In addition, wobbling or play of the pipette tip inserted into a receptacle is reduced. The smaller lower diameter minimizes lateral movement, which means that the tip sits more securely in the tray and prevents the tips from popping out of the receptacle. In addition, friction locking at at least one of the first and the second edge may make it more difficult for the tips to pop out. Furthermore, damage to the tips or tip receptacles is avoided. The reduced lateral movement prevents (or reduces) damage to the tip receptacles.

The wall areas may be at least partially conical.

The wall areas may be at least partially sleeve-like and preferably they may delimit a cylindrical receptacle space. Alternatively, however, the wall areas may be tapered (cone-shaped, truncated cone-shaped) from the first opening to the second opening, i.e. they may define an interior space that tapers (cone-shaped, truncated cone-shaped) from the first opening to the second opening. The constrictions may run continuously and/or steplessly from a first constriction to a second constriction. In this way, a conical surface adapted to the outer wall of the pipette tip may be formed between the first constriction and the second constriction.

The first constriction may be designed to support a support step formed in the pipette tips and/or to delimit at least a horizontal movement of the pipette tips.

The first edges (of the openings or constrictions) may be designed to support a support step formed in the pipette tips and/or to delimit at least a horizontal movement of the pipette tips. In this context, locking against horizontal movement means fixing in the x-y plane, which is to be defined as the horizontal plane. The term ‘horizontal’, like other terms relating to orientation and position (e.g. “top”, ‘bottom’, etc.), is to be understood only in relation to the orientations or positions of other components. Thus, the direction and position specifications “top”, “bottom”, “above”, “side”, etc. are not to be understood as absolute, but relative to the directions/positions of other components. For example, “horizontal” means a plane x-y specified in the figures, “top” means “located in the positive z-direction”, etc. The longitudinal direction and the central axis of the openings or inserted pipette tips correspond to the orientation of the z-axis.

The horizontal limitation of the mobility of the pipette tips is a limitation in a direction diagonal or perpendicular to the direction of insertion of the pipette tips into the receiving spaces (negative z-direction). The spaced horizontal limitation provided by the first constriction and the respective second constriction reliably prevents the pipette tips inserted into the tray from tilting or tipping over.

The second edges may be designed in particular to abut against an outer wall of an inserted pipette tip and to limit at least one horizontal movement of the pipette tip. The double fixation with regard to horizontal translation x-y at an axial distance t (FIG. 4) or t2 (FIG. 10) prevents the inserted pipette tip from tilting, enabling safe and precise positioning.

In principle, at least one of the first edges and the second edges may be used to support a projection formed in the pipette tips or a support step formed in the pipette tips. Vertical movement could be prevented by the second edges if, for example, the pipette tip tapers conically in this area and thus finds a vertical stop in the second edge.

The second constriction may be designed to rest against an outer wall of an inserted pipette tip and to limit at least a horizontal movement of the pipette tip.

The second constrictions may be formed by projections extending obliquely or perpendicularly from the wall area of the receptacle towards the central axis of the receptacle.

The projections may, for example, be webs, flange sections or wall sections with indentations, the edges of which (at least partially) delimit the second openings or form sub-areas of the second edges. Usually, the projections extend vertically from the wall areas of the receptacles.

In particular, the tray may be designed so that the inserted pipette tips rest on at least one of the respective first edge and the respective second edge and a projection of one of the constrictions. This provides additional locking against movement in the negative z-direction.

In particular, the receptacles are designed as openings, each of which has a proximal end, wherein the proximal end has a first edge that delimits a first opening, and the openings have a distal end, wherein the distal end has a second edge that delimits a second opening, wherein the first opening corresponds to the first constriction and the second opening corresponds to the second constriction.

In an alternative embodiment, at least one of the receptacles may be closed at the distal end (bottom) by a closure.

One or more of the openings may be at least partially delimited by wall areas, each of which has a proximal end of the wall area adjoining the respective first edge and a distal end of the wall area adjoining the respective second edge or the closure, wherein a pipette tip extends through at least the first opening when inserted.

The tray may be designed such that an inserted pipette tip rests on at least one of the first edge and the respective second edge and a projection of one of the constrictions of one of the receptacles.

A combination according to the invention of a tray for receiving pipette tips as described above and at least one pipette tip has a support step for resting on at least one of a respective first edge, a respective second edge, and a projection of one of the constrictions of one of the receptacles.

The pipette tip has, in particular, a proximal end and a distal end, wherein the outer diameter in a proximal region (D, D2) corresponds to a diameter of one of the first constrictions, and the outer diameter in a distal region (d0) corresponds to a diameter of the respective second constriction.

The outer diameter of the inserted pipette tip is preferably located in the proximal region (D, D2) at the first height by a distance (t, t2) above the second height of the outer diameter in the distal region (d0).

As a further aspect of the invention, a device for holding pipette tips comprises: at least one tray (placement part) having at least one placement or holding area with a plurality of openings for inserting pipette tips, wherein the tray comprises electrically conductive material for dissipating electrostatic charge from the pipette tips.

A problem with the use of plastic pipette tips may arise when pipette tips become electrostatically charged during handling. Static charging of the pipette tips and other components of the holder may cause the tips to repel each other, which may result in the tips being aligned differently than intended in the tray. As a result, interaction with pipetting devices or automated pipetting systems may be adversely affected, leading to inaccurate handling and thus to faulty analyses. Electrostatic charge may be transferred to a user of a pipetting device in an undesirable manner. In addition, highly sensitive measuring instruments may be affected by static charge.

Furthermore, static charge may prevent the pipette tips from being effectively detached from the pipetting device.

The tray may be made entirely or partially of electrically conductive material, or may only have electrically conductive material in certain areas or may have conductor tracks/lines made of electrically conductive material. It is crucial that an electrically conductive connection is established between the pipette tips inserted into the openings of the tray and a support or base on which the device stands (standing surface), via which electrostatic charge may be dissipated from the pipette tips to the base, thereby providing a kind of grounding of the pipette tips.

The conductor track may be, for example, a (possibly flat, thin) coating, an injection-molded track, an element incorporated into the device, e.g., a wire, or similar. An injection-molded track may be produced, for example, in a 2K (2-component) injection molding process.

In particular, the device comprises a carrier (rack) for carrying the tray, wherein the carrier has a frame with a window arranged in the upper area of the frame for inserting the tray, and a base surface (standing surface) arranged in the lower area of the frame.

The tray and the carrier may be formed as a single piece or as multiple pieces. In particular, the device comprises a carrier (rack) for carrying the tray, wherein the carrier and the tray are formed as a single piece to form a combined carrier/tray component, which has a standing surface arranged in the lower region of the component.

The carrier may comprise electrically conductive material for dissipating electrostatic charge from the tray to the standing surface.

The tray and the carrier, respectively, or the combined carrier/tray component may be made of electrically conductive material.

The tray and the carrier, respectively, or the combined carrier/tray component may comprise conductive plastic/resin.

The tray and the carrier, respectively, or the combined carrier/tray component may comprise at least one conductor track which is designed to establish an electrical connection between the openings of the tray and the surface of the base.

The at least one conductor track may be made of electrically conductive material.

The conductor track may be made of electrically conductive plastic/resin. However, alternatively, metal (e.g., in the form of a coating, wire, or foil) may be used as the conductive material.

In particular, the conductor track may have contact areas or connection areas. The contact areas are arranged in particular in the area of the openings of the tray.

The electrically conductive material may be integrated in the material of the tray and the carrier, respectively, or in the combined carrier/tray component and/or arranged as a coating on the tray and/or on the rack or on the combined rack/tray component.

### BRIEF DESCRIPTION OF THE FIGURES

Further features and advantages of the invention will become apparent from the following description with reference to the figures. The figures show:

FIG. 1 a perspective view of a first embodiment of a device for holding pipette tips according to the present invention;

FIG. 2 a Side View of the First Embodiment;

FIG. 3 a perspective sectional view of a second embodiment of a device for holding pipette tips according to the present invention;

FIG. 4 a side sectional view of the second embodiment;

FIG. 5 a perspective view of a third embodiment of a device for holding pipette tips according to the present invention;

FIG. 6 a side view of the third embodiment;

FIG. 7 a perspective view of a carrier of the third embodiment;

FIG. 8 a perspective view of a tray of the third embodiment;

FIG. 9 a side sectional view of a tray of a fourth embodiment without pipette tips;

FIG. 10 a section of the side sectional view of the fourth embodiment with pipette tips;

FIG. 11 a Detail of FIG. 10.

### DESCRIPTION OF PREFERRED EMBODIMENTS OF THE INVENTION

The invention generally relates to the provision of medical components or laboratory components with improved handling, in particular improved positioning of pipette tips or sample containers in a tray. As a secondary aspect, medical components are described which may be used to remedy problems with electrostatic charge that may arise during and as a result of the handling of pipette tips.

### Pipette Tip Holders

A pipette tip holder or tray is an arrangement of components that provides pipette tips for use by a user. Pipette tip holders often feature at least one carrier (‘rack’) or container, a lid and a tray in which the pipette tips are held, with the pipette tips arranged in an essentially immovable array in the tray.

The tray is arranged on the top of the carrier and has openings for receiving and holding pipette tips. The tray may be formed integrally with the carrier, e.g., molded onto it, or the tray may form a separate unit or component that is attached to the carrier, e.g., by a snap or latch connection, by gluing, welding, etc.

The pipette tips used are inserted removably into the openings of the tray. The tray has an upper surface facing upwards, and a lower surface facing downwards. The pipette tips usually rest on the edge of one of the openings of the tray. The pipette tips received in the openings may protrude upward beyond the edge and the upper surface of the tray, while the lower portion of the pipette tips is usually located below the lower surface of the tray. The tray may have a suitable number of openings, e.g., 8×n (n=1, 2, . . . , 432) openings.

Each component of the pipette tip holder may be made of a suitable material, e.g., one or more plastic materials, e.g., polypropylene (PP), polyethylene (PE), polyethylene terephthalate (PET), polycarbonates, polyvinyl chloride (PVC), polyethylene fluoroethylene (PEFE), polystyrene (PS), polysiloxanes, polyurethane, cellulose, polyamide (PA), etc.

The components of the pipette tip holder or tray may be moulded individually and then assembled. Thermoforming, extrusion or moulding processes (such as plastic injection moulding) are possible manufacturing methods for the components.

The components of the pipette tip holder are assembled or joined together. However, they may also be manufactured using a 2-component injection moulding process. The cover may be placed precisely on the holder, e.g. engaging in a groove or recess arranged in the holder. The cover may be loosely or movably connected to the holder, e.g. via plug connections, or pivotable via a hinge.

Pipette Tips Pipette tips with different geometries are known. The geometry of a pipette tip is adapted so that it is suitable for picking up and dispensing liquids in conjunction with a coupling device of a pipetting device or automatic pipetting device. Pipette tips are usually available in different sizes, e.g. 10 microlitres, 50 microlitres, 100 microlitres, 250 microlitres, 1000microlitres, 2500 microlitres, etc.

The outer contour and the inner contour of pipette tips are adapted for use in conjunction with or interaction with a specific pipetting device or pipetting machine. Usually the outer contour of pipette tips tapers from the upper (proximal) section to the lower (distal) section, wherein the lower distal section has a small opening. The outer and inner contour is suitable for allowing attachment to a coupling device of a pipetting device or pipetting machine.

The inner wall of the pipette tip delimits a substantially tapered inner volume, whereby enlargements of the inner diameter or projections extending inwards may also be provided in sections. The taper may be continuous and/or stepped, steady and/or unsteady, either overall or in sections. It must be ensured that a fluid taken up has suitable fluid flow properties and may be attached to a coupling device. In most embodiments, a pipette tip wall comprises at least two taper angles.

The outer and inner walls have a substantially tapered, for example stepped or conical, contour. The taper angle(s) is/are approximately between 0° and 30° relative to the central longitudinal axis, e.g. 0°, 5°, 10°, 15°, 20°, 25°, 30°. In some embodiments, the contour is stepped or cylindrical. Steps or stops or grooves may also be provided.

A typical conventional pipette tip has a total length of approximately 2.5 cm to 10 cm. The distal dispensing opening typically has an inner diameter of between approximately 0.2 mm and 0.8 mm, e.g. 0.2 mm, 0.3 mm, 0.4 mm, 0.5 mm, 0.6 mm, 0.7 mm, 0.8 mm. The wall thickness in this area is approximately 0.1 mm and 0.5 mm, e.g. 0.1 mm, 0.2 mm, 0.3 mm, 0.4 mm, 0.5 mm.

In the proximal area, the inner diameter is approximately 2.5 mm to 10 mm, e.g. 2.5 mm, 5 mm, 7.5 mm, 10 mm, with a typical wall thickness in the proximal section between 0.5 mm and 1.5 mm, e.g. 0.5 mm, 0.75 mm, 1.0 mm, 1.25 mm, 1.5 mm.

The wall thickness may be constant along a section or may vary continuously and/or in steps.

A proximal or distal section of a pipette tip may contain a filter, an insert or other auxiliary material.

In an embodiment, (disposable) pipette tips comprise: a wall defining an interior space; a first, upper opening and a second, lower opening located at the upper end and lower end of the interior space, respectively; a first section adjoining the upper opening; a second section adjoining the first section; a third section adjoining the second section; a fourth section adjoining the third section; and a fifth section adjoining the fourth section and opening into the lower opening; a first transition area between the first section and the second section; a second transition area between the second section and the third section; a third transition area between the third section and the fourth section; wherein the sections and the transition areas may have an inner contour or inner geometry or a configuration as described below in the description of the invention.

The terms “top”, “above”, “upper” refer to an area of the wall or interior of the pipette tip closer to the first, upper opening, into which a retaining/sealing mandrel of the pipetting machine may penetrate as intended in order to hold and seal the pipette tip. The terms “bottom”, “below”, “lower” refer to an area of the wall or interior of the pipette tip closer to the second, lower opening, through which the pipetted fluid is intended to be taken up or dispensed during operation. The upper opening is usually larger than the lower opening.

The direction “from top to bottom” means the axial direction from the upper opening to the lower opening. “Axial” is a direction perpendicular to a plane defined by the upper and/or lower edge of the pipette tip. ‘Radial’ means a direction parallel to the plane defined by the upper and/or lower edge of the pipette tip, i.e., perpendicular to “axial”. A taper or cross-sectional reduction from top to bottom means that the cross-section at a position closer to the first opening is larger than the cross-section at a position closer to the second opening. A widening or cross-sectional enlargement occurs when the cross-section at a position closer to the first opening is smaller than the cross-section at a position closer to the second opening. This applies to both the sections of the pipette tip and the transition areas.

Sections of the wall or interior of the pipette tip have an axial and, optionally, a radial extension. Transition areas of the wall or interior of the pipette tip may have an axial extension and/or a radial extension. However, they may also be designed without axial/radial extension as a continuous transition, e.g., as an edge.

An undercut exists in the case of a widening or cross-sectional enlargement (when viewing the interior through the upper opening in the direction of the lower opening), as described above. An undercut may be a continuous transition with or without axial extension. A pipette tip according to the invention comprises: a wall delimiting an interior space; a first, upper opening and a second, lower opening, which are arranged at the upper end and the lower end of the interior space, respectively; a first section, which is connected to the upper opening; a second section, which is connected to the first section; a third section, which is connected to the second section; a fourth section, which is connected to the third section; and a fifth section adjoining the fourth section and opening into the lower opening; a first transition area between the first section and the second section; a second transition area between the second section and the third section; a third transition area between the third section and the fourth section); wherein the diameter of the upper opening is greater than the diameter of the lower opening; wherein the interior space has at least sectionally cylindrical and/or tapered sections and/or transition areas from top to bottom.

Optionally, the interior may have at least one section and/or transition area that widens from top to bottom, so that an undercut is formed.

Pipette tips may be provided individually or as several pipette tips connected, e.g., in a strip (1×6 tips) or in an array (e.g., 2×3 tips).

### Electrically Conductive Pipette Tip Holders

The pipette tips should be arranged in a substantially immovable manner in a tray according to the invention and be in contact with an electrically conductive element that extends to the openings of the tray.

Such pipette tip holders (trays, containers, carriers, etc.) have the advantage that electrostatic charging of the pipette tips contained in the pipette tip holder is prevented by dissipating the charge to a grounded object. The pipette tips contact the electrically conductive tray and are thus in electrically conductive contact with the bottom area of the carrier. Instead of dissipation via the bottom area, it would also be conceivable to dissipate the charge via an external grounding contact with the tray or carrier.

One or more components of the device may be made of an electrically conductive material and/or contain one or more other materials that are not electrically conductive but do not significantly affect the conductivity of the conductive material.

The electrically conductive material may comprise any type of known electrically conductive material, such as electrically conductive metal, which may be arranged at the respective component of the holding device, e.g., in the form of metal coatings, films attached to the component, or within a matrix, e.g., in the form of metal powder. Carbon is another suitable electrically conductive material that may be embedded in a carrier material to provide electric conductivity.

It is preferred that the pipette tips, or at least parts thereof, are in contact with the electrically conductive material of the tray, e.g., via the contact points or support surfaces between the pipette tip and the tray. The tray is electrically conductive in such a way and to such an extent that the electrostatic charge may be dissipated from the pipette tips.

A method for discharging static electricity from pipette tips into a device for holding pipette tips comprises the step of: providing a pipette tip holding device comprising a carrier, a tray, optionally a lid, and pipette tips, wherein the tray comprises conductive material that is in contact with the pipette tips received on the openings of the tray.

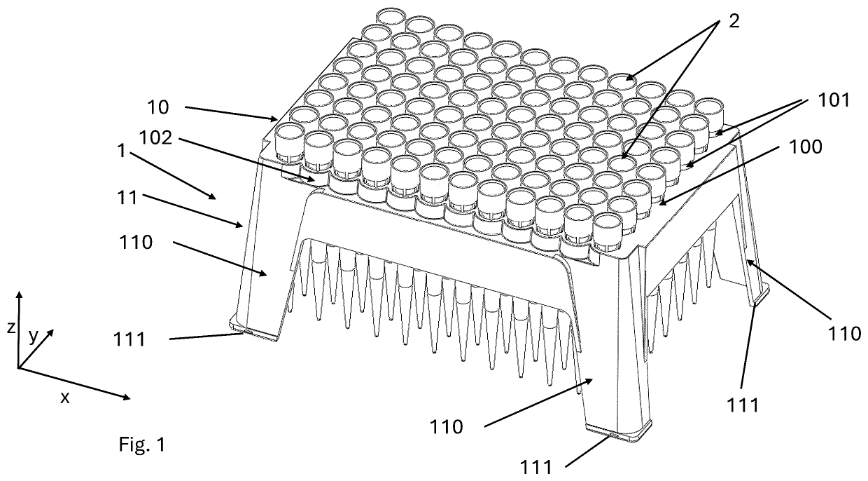

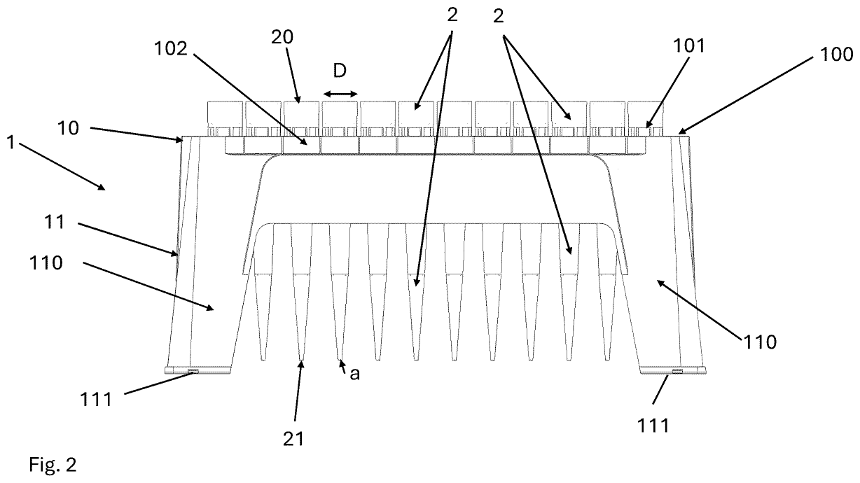

Coating methods may be used to produce electrically conductive lines, e.g., vapor deposition of metal layers, or conductive material may be incorporated in a matrix of the material forming the components of the holding device. The component with the conductive material may be molded or cast, whereby antistatic materials may be added before or during molding. FIGS. 1 and 2 show a first embodiment of the invention. A device 1 according to the invention for holding pipette tips 2 has a tray 10 (placement or holding plate) with a holding area 100 and openings or cutouts 101 formed in the holding area 100, which are adapted to the shape of the pipette tips 2 in order to hold them in a specific position. The cutouts 101 may, for example, be bounded by sleeves 102.

The pipette tips 2 (as described above) may rest on the edge of the corresponding opening 101 or the corresponding sleeve 102. The pipette tips 2 may, for example, be lifted out of the openings 101 or inserted into the openings 101 by an automated liquid handling system (not shown).

The pipette tips 2 have an upper opening 20 with an (outer) diameter D and an (outer) diameter d that decreases to a lower opening 21 (with an outlet (outer) diameter a). The upper opening 20 is defined/bounded by an upper edge 200.

In the lower region, the device 1 has a support 11 comprising four legs 110 extending downwards from the tray 10. A base 111 is formed on the underside of each of the legs 110, by means of which the device 1 stands, for example, on the base of a liquid handling system. In this embodiment, tray 10 and support 11 are formed in one piece.

The pipette tips 2 may be made of electrically conductive or non-conductive material. The materials, in particular plastic materials, may be more or less transparent or more or less opaque.

However, the pipette tips 2 arranged in tray 10 may become electrostatically charged at certain stages of their service life, for example during manufacture, transport or during use in the liquid handling system, which leads to undesirable effects.

To counteract this problem, device 1 (i.e., tray 10 and carrier 11) is made of electrically conductive plastic in order to establish an electrical connection from the pipette tips 2 to the base 111 of device 1, whereby electrostatic charge may be dissipated from the pipette tips to the bottom of the liquid handling system. In this way, interference during the intake/discharge of liquids into/from the interior of the pipette tips 2, during measurements, during fluid transfer, etc., is prevented.

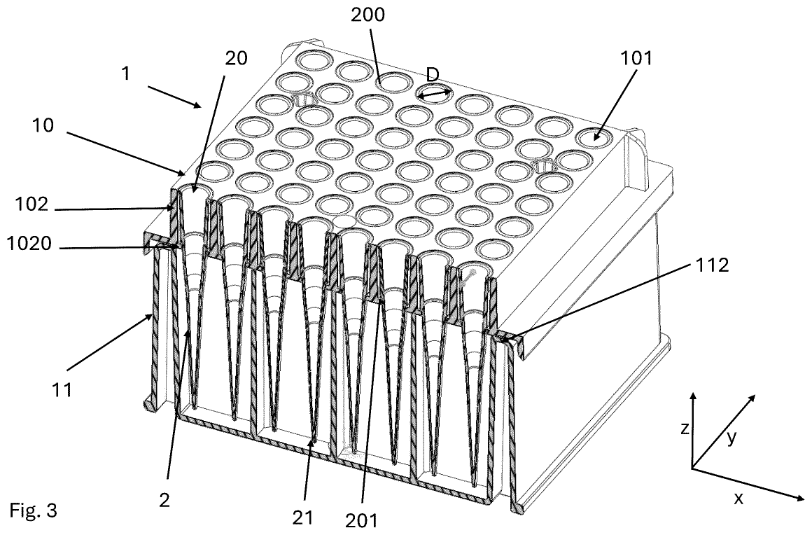

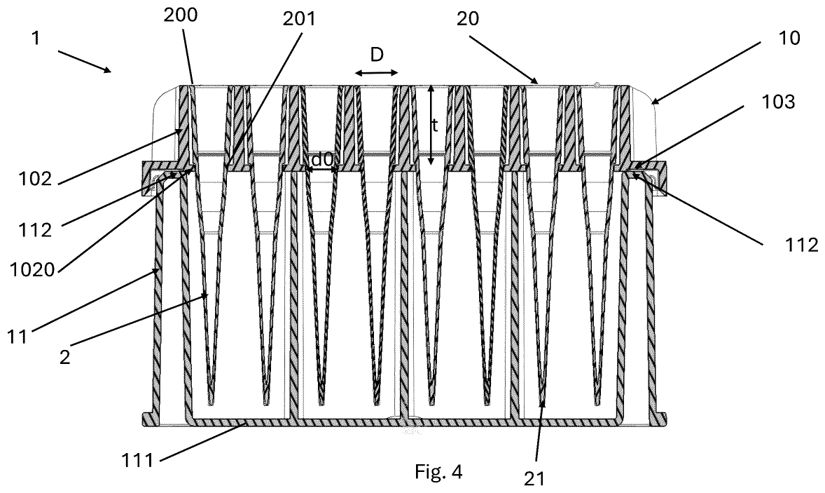

FIGS. 3 and 4 show a second embodiment of the device 1 according to the invention in a perspective view with a section through a vertical plane and as a side view in a cross-section, respectively.

Corresponding components are designated with the same reference numerals as in the first embodiment. As described in the previous embodiment, a tray 10 is fixedly connected or removably mounted on a carrier 11, in particular on one or more shoulders 112 of the carrier 11.

The pipette tips 2 have an upper opening 20 with an (outer) diameter D and an (outer) diameter d that decreases towards a lower opening 21 (with an outlet (outer) diameter a). The upper opening 20 is defined/bounded by an upper edge 200.

At a depth t, the pipette tip has a support step 201. Pipette tips 2 are arranged in sleeves 102 of the tray 10. The pipette tips 2 have an outer contour such that they may rest on inner projections 1020 of the sleeves 102.

The inner projections 1020 may essentially be webs projecting in the direction of the central axis of the inserted pipette tip 2, which extend perpendicularly from a lower end of the sleeves 102. The inner projections 1020 protrude so far inwards in the direction of the central axis of the inserted pipette tip 2 that they rest against the outer wall of the pipette tip, which has an outer diameter do in this area. In this embodiment, the step 201 of the pipette tip 2 rests on the inner protrusions 1020. The inner protrusions 1020 may extend completely or partially around the circumference do of the pipette tip 2, but there are at least two, in particular two, preferably three contact points with the outer wall of the pipette tip 2.

Overall, the upper edge 200 of the inserted pipette tip 2 is fitted into the upper area of the associated sleeve 102 and is thus fixed against translational movements in the x-y direction. In the depth t, the outer wall of the pipette tip 2 is fixed against translational movements in the x-y direction by the inner projection or projections 1020. This fixes the pipette tip 2 against tilting and holds it securely in the sleeve 102.

In this embodiment, too, the device 1 (i.e. in particular tray 10 and carrier 11) may optionally be made of electrically conductive plastic in order to establish an electrical connection from the pipette tips 2 to the base 111 of the device 1, so that electrostatic charge may be dissipated from the pipette tips 2 to the base of the liquid handling system.

The electrostatic charge may flow off in particular via a support surface 103 of the tray 10 and the shoulder(s) 112 of the carrier 11.

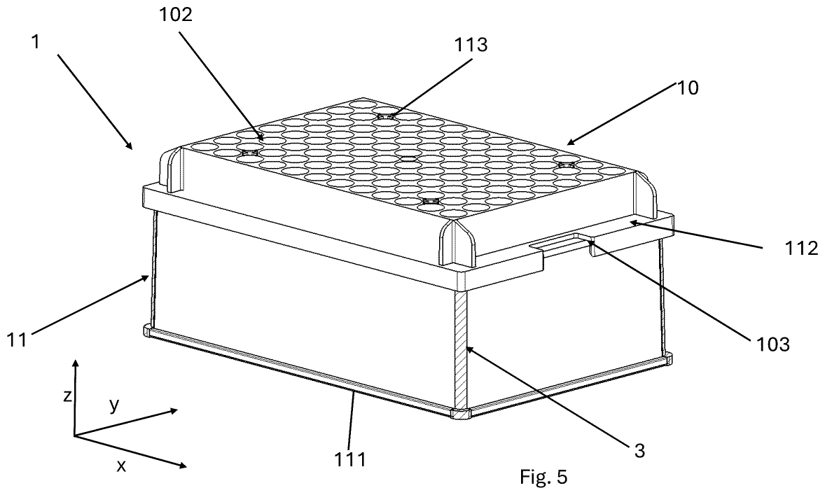

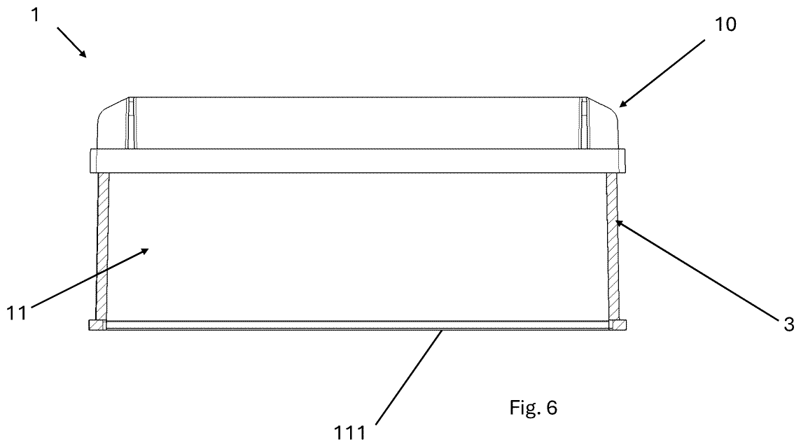

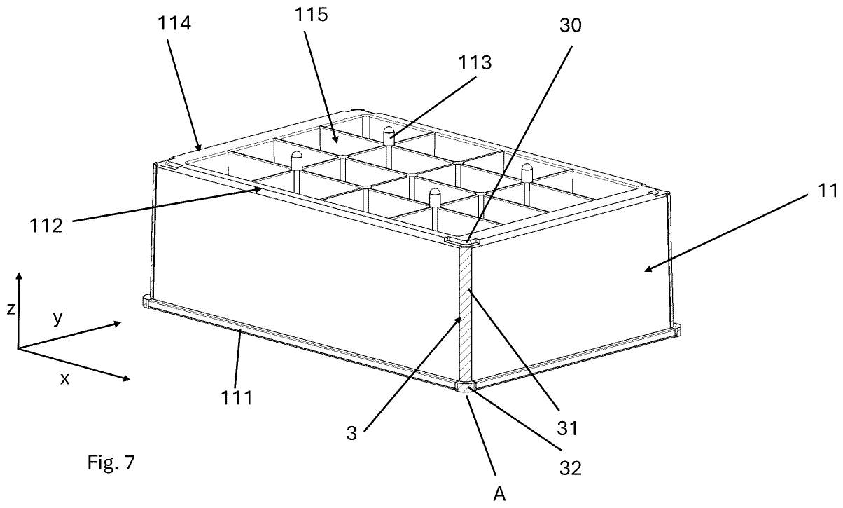

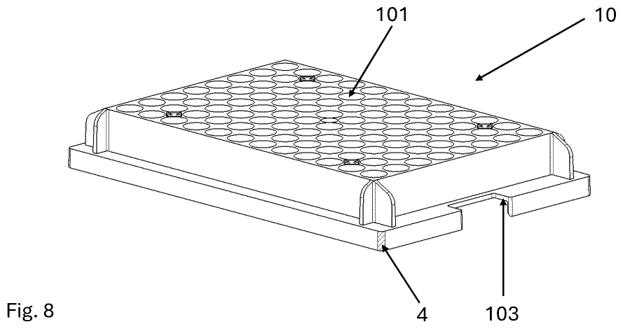

FIGS. 5 to 8 show a third embodiment of the device 1 according to the invention. FIGS. 5 and 6 show the entire device 1, while FIGS. 7 and 8 show the carrier 11 and the tray 10, respectively.

The tray 10 is made of electrically conductive plastic in order to conduct electrostatic charge from the pipette tips 2 inserted into the carrier 11.

In this embodiment, the carrier 11 may be made of non-conductive plastic. In this case, conductor tracks 3 are arranged on the four vertical edges (shaded). The conductor tracks 3 may be clipped into the component or injected or moulded in a 2K (2-component) injection moulding process. The conductor tracks 3 are made of electrically conductive material, e.g. of electrically conductive plastic.

As may be seen in particular in FIG. 7, each of the conductor tracks 3 consists of an upper first contact area 30 for establishing electrical contact with the tray 10, and a connecting area 31 between the first contact area 30 and a second contact area 32 for establishing electrical contact with the support surface A of a pipetting device (not shown).

In addition, the carrier 11 has positioning pins 113 which, when assembled, engage in corresponding counter bearings (e.g. openings) of the tray 10. Furthermore, the carrier 11 has a frame 114 which surrounds a window 115 into which the tray 10 may be inserted.

In order to establish improved electrical contact between the tray 10 and the carrier 11 or the conductor track 3, conductive areas 4 may also be formed or arranged in the corners of the angled support area 103 in the tray. When assembled, they are connected to the first contact areas 30 of the carrier 11.

Inserted pipette tips 2 extend through the openings 101 of the tray 10 and the window 115 of the carrier 11 into an interior space of the carrier 11.

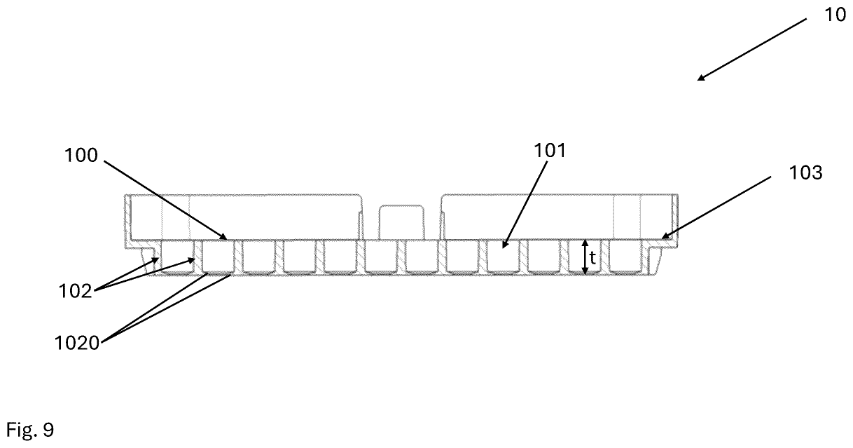

FIGS. 9 to 11 show a fourth embodiment of a tray 10 according to the invention. Corresponding components are designated with the same reference numerals as in the embodiments described above.

FIG. 9 shows the tray 10 without inserted pipette tips. The tray 10 has a holding area 100 and receptacles which, in this embodiment, are designed as through holes 101, formed in the holding area 100, which are adapted to the shape of the pipette tips to be inserted in order to hold them in a specific position. The (cylindrical) through holes 101 may, for example, be bounded by sleeves 102.

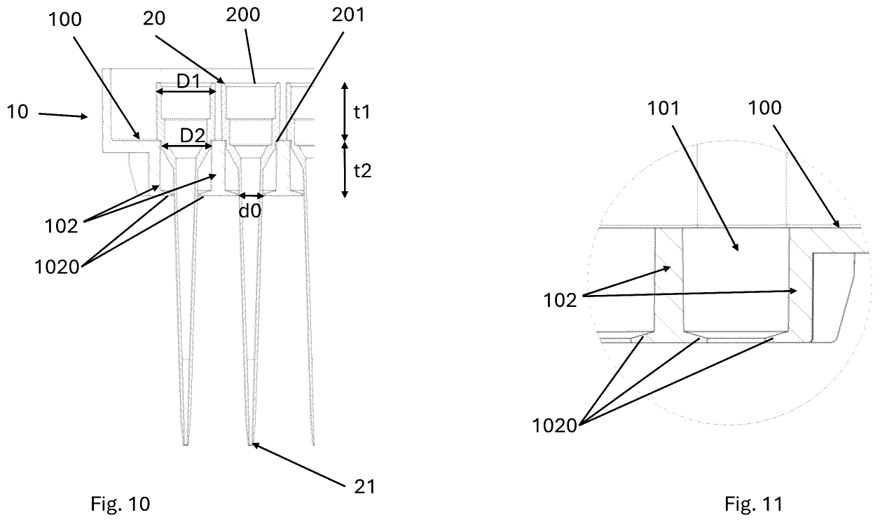

As may be seen particularly clearly from FIG. 10, the pipette tips 2 are arranged in the sleeves 102 of the tray 10. The pipette tips 2 have an outer contour with a support step 201 such that they rest on the edge of the corresponding opening of the through hole 101.

The inner projections 1020 may essentially be webs projecting in the direction of the central axis of the inserted pipette tip 2, which extend vertically from a lower end of the sleeves 102. The inner projections 1020 protrude so far inwards in the direction of the central axis of the inserted pipette tip 2 that they rest against the outer wall of the pipette tip 2, which has an outer diameter do in this area. The inner protrusions 1020 may extend completely or partially around the circumference do of the pipette tip 2, but there are at least two, in particular three, contact points with the outer wall of the pipette tip 2.

The pipette tips 2 have an upper opening 20 with an (outer) diameter D and an (outer) diameter d that decreases to a lower opening 21 (with an outlet (outer) diameter a). The upper opening 20 is defined/bounded by an upper edge 200. At a depth t1, the pipette tip has a support step 201. At a depth t1+t2, the pipette tip has an outer diameter d0. At this point, one end of the inner projection 1020 or the ends of the inner projections 1020 of the respective sleeve 102 contact the outer wall of the inserted pipette tip 2.

This means that the inserted pipette tip 2 is fitted into the upper area of the associated sleeve 102 in the area of the support step 201 (at a depth of t1) and is thus fixed against translational movement in the x-y direction. At a depth t1+t2, the outer wall of the pipette tip 2 is fixed against translational movement in the x-y direction by the inner protrusions 1020, thereby fixing the pipette tip 2 against tilting and holding it securely in the sleeve 102.

In this embodiment, the tray 10 may be made of electrically conductive plastic in order to establish an electrical connection from the pipette tips 2 to a carrier, so that electrostatic charge may be dissipated from the pipette tips 2 to the bottom of the liquid handling system. The electrostatic charge may thus flow away via the tray 10.

Instead of pipette tips, sample vessels may be used in all embodiments. The sample vessels differ from the described pipette tips in particular in that they do not have a lower opening, but rather a lower closure through which their lower (distal) end is closed. The lower closure may have different internal and external geometries, e.g. pyramidal, bowl-shaped (rounded), flat, etc.

1. A tray for holding pipette tips, the tray comprising:
at least one placement or holding area; and
a plurality of receptacles formed in the placement or holding area, the at least one placement or holding pipette tip of the pipette tips, at least one of the receptacles being configured to receive to the pipette tip to be inserted such that the pipette tip is locked against horizontal translations at a first height and a second height, the second height being spaced apart from the first height by a distance.

2. The tray for holding pipette tips according to claim 1, wherein at least one of the receptacles has a first constriction disposed at the first height and a second constriction disposed at the second height.

3. The tray for holding pipette tips according to claim 2, wherein a diameter of the first constriction is even or greater than a diameter of the second constriction.

4. The tray for holding pipette tips according to claim 2, wherein the first constriction has a first edge that delimits a first opening,
wherein the second constriction has a second edge that delimits a second opening,
wherein one or more of the receptacles are at least partially delimited by wall areas, each of the wall areas having a proximal end of the wall area that adjoins the respective first edge, and a distal end of the wall area that adjoins the respective second edge,
wherein at least one of the pipette tips extends through at least the first constriction and the second constriction when inserted,
wherein the first constriction is disposed between an upper opening of one of the receptacles and a lower end of the one receptacle, and the second constriction is disposed below the first constriction and between the first constriction and the lower end of the receptacle.

5. The tray for holding pipette tips according to claim 4, wherein the wall areas are at least partially conical in shape.

6. The tray for holding pipette tips according to claim 4, wherein the wall areas are at least partially sleeve-shaped.

7. The tray for holding pipette tips according to claim 2, wherein
the first constrictions are configured to at least one of: support a support step formed in the pipette tips and delimit at least one horizontal movement of the pipette tips.

8. The tray for holding pipette tips according to claim 2, wherein
the second constrictions are configured to bear against an outer wall of the inserted pipette tip and delimit at least one horizontal movement of the inserted pipette tip.

9. The tray for holding pipette tips according to claim 2, wherein
the second constrictions are formed by projections extending obliquely or perpendicularly from the wall areas of the receptacles in a direction of the central axis of the receptacles.

10. The tray for holding pipette tips according to claim 2, wherein the receptacles are formed as through holes, each of the through holes having a proximal end, having a first edge that delimits a first opening, the through holes having a distal end, having a second edge that defines a second opening,
wherein the first opening corresponds to the first constriction and the second opening corresponds to the second constriction.

11. The tray for holding pipette tips according to claim 4, wherein
the tray is configured such that the inserted pipette tip rests on at least one of the respective first edge, the respective second edge, and a projection of one of the constrictions of one of the receptacles.

12. A system comprising:
at least one pipette tip; and
the tray configured to hold the at least one pipette tip according to claim 1; the at least one pipette tip having a support step for configured to rest on at least one of a respective first edge, a respective second edge, and a projection of one of the constrictions of one of the receptacles.

13. The combination according to claim 12, wherein
the at least one pipette tip has a proximal end and a distal end, the outer diameter in a proximal region corresponding to a diameter of one of the first constrictions, the outer diameter in a distal region corresponding to a diameter of the respective second constriction.

14. The combination according to claim 13, wherein
the outer diameter of the at least one pipette tip inserted in the receptacle in the proximal region located at the first height, is at a distance above the second height of the outer diameter in the distal region.

15. A system comprising:
at least one pipette tip; and
the tray configured to hold the at least one pipette tip according to claim 4, the at least one pipette tip having a support step configured to rest on at least one of the respective first edge, the respective second edge and a projection of one of the constrictions of one of the receptacles.

16. The combination according to claim 15, wherein
the at least one pipette tip has a proximal end and a distal end, the outer diameter in a proximal region corresponding to a diameter of one of the first constrictions, the outer diameter in a distal region c_to a diameter of the respective second constriction.

17. The combination according to claim 16, wherein
the outer diameter of the at least one pipette tip inserted in the receptacle in the proximal region, located at the first height, is at a distance above the second height of the outer diameter in the distal region.
